(19) United States
(12) Patent Application Publication
(10) Pub. No.: US 2002/0182142 A1
(43) Pub. Date: Dec. 5, 2002

(54) Process for the catalytic partial oxidation of a hydrocarbonaceous feedstock

(76) Inventors: David Schaddenhorst, Amsterdam (NL); Ronald Jan Schoonebeek, Amsterdam (NL)

Correspondence Address: Richard F Lemuth, Shell Oil Company, Intellectual Property, PO Box 2463, Houston, TX, 77252-2463, US

(21) Appl. No.: 10/149,681

(22) PCT Filed: Dec. 20, 2000
(86) PCT No.: PCT/EP00/13112

(30) Foreign Application Priority Data
Dec. 21, 1999 (EP) 99310346.4

(51) Int. Cl. C01B 3/26

(52) U.S. Cl. 423/651

(57) ABSTRACT

A process for the catalytic partial oxidation of a hydrocarbonaceous feedstock comprising contacting the hydrocarbonaceous feedstock and an oxygen-containing gas with a catalyst in a reaction zone, wherein the catalyst comprises at least one metal selected from Group VIII of the Periodic Table supported on a ceramic or metal catalyst carrier, which carrier is coated with a stabilized or partially stablized zirconia.

The present invention relates to a process for the catalytic partial oxidation of a hydrocarbonaceous feedstock.

Partial oxidation of a hydrocarbonaceous feedstock, in particular hydrocarbons, in the presence of a catalyst is an attractive route for the preparation of mixtures of carbon monoxide and hydrogen, normally referred to as synthesis gas. The partial oxidation of hydrocarbons is an exothermic reaction represented by the equation:

CnH₂n+₂+n/₂O₂→nCO+(n+1)H₂

The catalytic partial oxidation process could very suitably be used to provide the hydrogen feed for a fuel cell. In fuel cells, hydrogen and oxygen are passed over the fuel cell in order to produce electricity and water. Fuel cell technology is well known in the art.

There is literature in abundance on the catalysts and the process conditions for the catalytic partial oxidation of hydrocarbons. Reference is made, for instance, to EP-A-303 438, U.S. Pat. No. 5,149,464, EP-B-576 096, WO 99/37380, and WO 99/19249.

However, there is still a need for catalysts for the catalytic partial oxidation of hydrocarbonaceous feedstocks having an improved performance, especially in terms of yield of the desired conversion product and maintaining a high yield after many hours on stream, i.e. catalyst stability.

It has now been found that the catalyst performance in a process for the catalytic partial oxidation of a hydrocarbonaceous feedstock, especially the initial yield and the catalyst stability can be improved by coating the catalyst carrier with stabilised or partially stabilised zirconia.

Accordingly, the present invention relates to a process for the catalytic partial oxidation of a hydrocarbonaceous feedstock comprising contacting the hydrocarbonaceous feedstock and an oxygen-containing gas with a catalyst in a reaction zone, wherein the catalyst comprises at least one metal selected from Group VIII of the Periodic Table supported on a ceramic or metal catalyst carrier, which carrier is coated with a stabilised or partially stabilised zirconia.

Catalysts suitable for the catalytic partial oxidation of a hydrocarbonaceous feedstock are known in the art. Suitable catalysts typically comprise at least one metal selected from Group VIII of the Periodic Table as catalytically active metal supported on a high-temperature resistant catalyst carrier. In the process according to the present invention, the catalyst carrier is coated with a stabilised or partially stabilised zirconia. The zirconia layer is coated on the catalyst carrier prior to applying the catalytically active metal(s) on it.

The stabilised or partially stabilised zirconia may be coated on the catalyst carrier by techniques known in the art, preferably by means of washcoating techniques such as spraying, dipping or direct application of a sol or suspension of zirconia. Preferably, the carrier is dried and calcined after washcoating. The sol or suspension of zirconia may comprise a small amount of other oxides or binders, for example alumina. Preferably, the amount of other oxides or binders is less than 20% by weight, based on the amount of stabilised zirconia, more preferably less than 10% by weight.

Preferably, the zirconia is stabilised with one or more oxides selected from oxides of Ca, Mg, Al, Ce, La, and Y, more preferably selected from Ca and Y. Preferably, the amount of stabiliser is in the range of from 1 to 10% by weight, based on the weight of stabilised zirconia, preferably in the range of from 3 to 7% by weight.

Preferably, the amount of stabilised or partially stabilised zirconia coated on the catalyst carrier is in the range of from 1 to 40% by weight, based on the weight of catalyst carrier, more preferably in the range of from 2 to 30% by weight, even more preferably in the range of from 3 to 15% by weight.

The catalyst of the process of the present invention may be retained in the reaction zone in any suitable form, such as a slurry, a fluidised bed or in the form of a fixed arrangement. Preferably, the catalyst is retained in the reaction zone as a fixed arrangement. The fixed arrangement of catalyst may be in any suitable form, provided that it is permeable to gas. Examples of suitable fixed arrangements of catalyst are a fixed bed of catalyst particles, arrangements comprising a metal or ceramic monolithic structure as catalyst carrier, such as a foam or a honeycomb, or comprising an arrangement of metal wire, foil or gauze as catalyst carrier, or combinations thereof. Preferably the fixed arrangement of catalyst has a void fraction in the range of from 0.4 to 0.98, more preferably in the range of from 0.6 to 0.95.

The process of the invention is especially advantageous if a metal catalyst carrier is used, preferably a catalyst carrier comprising an aluminium-containing alloy, more preferably an alloy comprising iron, chromium and aluminium, such as fecralloy-type materials. Aluminium-containing alloys are preferably oxidised, for example by calcining at a temperature above 1000° C., prior to applying the coating of zirconia on it.

Preferred metal catalyst carriers are in the form a foam or an arrangement of metal wire, gauze or foil.

Typically, the catalyst comprises the catalytically active metal(s) in a concentration in the range of from 0.02 to 10% by weight, based on the total weight of the catalyst, preferably in the range of from 0.1 to 5% by weight. Preferably, the catalyst comprises at least one metal selected from Rh, Ir, Pt, and Pd as catalytically active metal, more preferably selected from Rh and Ir. An especially preferred catalyst comprises an alloy of Rh and Ir as catalytically active metal. Preferably, the catalyst additionally comprises a performance-enhancing inorganic metal cation selected from Al, Mg, Zr, Ti, La, Hf, Si, Ce and Ba, which is present in intimate association supported on or with the catalytically active metal(s), preferably a zirconium cation.

The process of the present invention is especially advantageous if the hydrocarbonaceous feedstock and the oxygen-containing gas are contacted with the catalyst for at least 5 hours, preferably for at least 10 hours.

Suitable hydrocarbonaceous feedstocks for the process according to the invention comprise hydrocarbons, oxygenates or mixtures thereof. Oxygenates are defined as molecules containing apart from carbon and hydrogen atoms at least 1 oxygen atom which is linked to either one or two carbon atoms or to a carbon atom and a hydrogen atom. Examples of suitable oxygenates are methanol, ethanol, dimethyl ether and the like. The hydrocarbonaceous feedstock is gaseous when contacting the catalyst, but may be liquid under standard temperature and pressure (STP) conditions, i.e. at 0° C. and 1 atmosphere. Preferred hydrocarbonaceous feedstocks are hydrocarbons.

The oxygen-containing gas may be oxygen, air, or oxygen-enriched air, preferably air.

The hydrocarbonaceous feedstock and the oxygen-containing gas are preferably present in the feed mixture in such amounts as to give an oxygen-to-carbon ratio in the range of from 0.3 to 0.8, more preferably in the range of from 0.35 to 0.65. References herein to the oxygen-to-carbon ratio refer to the ratio of oxygen in the form of molecules (O2) to carbon atoms present in the hydrocarbonaceous feedstock. If oxygenate feedstocks are used, e.g. methanol, oxygen-to-carbon ratios below 0.3 can suitably be used.

Preferably, the feed mixture additionally comprises steam. If steam is present, the steam-to-carbon ratio is preferably in the range of from above 0.0 to 3.0, more preferably of from above 0.0 to 2.0.

The feed mixture may be contacted with the catalyst at any suitable gas hourly space velocity (GHSV). In the process according to the invention, the GHSV will be typically in the range of from 20,000 to 10,000,000 Nl/kg/h.

The feed mixture may be contacted with the catalyst at a pressure up to 100 bar (absolute), preferably in the range of from 1 to 50 bar (absolute), more preferably of from 2 to 30 bar (absolute).

The invention will now be illustrated by means of the following examples.

### EXAMPLE 1

### Catalyst Preparation

Catalyst 1

A cylindrical arrangement (diameter: 14 mm; length of 15 mm; void fraction 0.79) of a commercially available fecralloy wire (wire diameter 0.2 mm; ex. Resistalloy, UK) comprising 72.6% wt Fe, 22% wt Cr, 5.3% wt Al, and 0.1% wt Y, was calcined at a temperature of 1050° C. during 48 hours. The calcined wire arrangement was provided with 0.9% wt Rh and 1.3% wt Zr, based on the total weight of the catalyst, by immersing it twice in an aqueous solution comprising rhodium trichloride and zirconyl nitrate. After each immersion, the arrangement was dried at 140° C. and calcined for 2 hours at 700° C.

Catalyst 2

An arrangement of fecralloy wire having the same composition and dimensions as that used in catalyst 1 was calcined at a temperature of 1050° C. during 48 hours. The calcined wire arrangement was once dipcoated in a commercially available partially-stabilised zirconia (Zirconium oxide, type ZO; ex. ZYP Coatings Inc., Oak Ridge, USA). The zirconia is partially-stabilised with 4% wt CaO. After dipcoating, the arrangement was calcined for 2 hours at 700° C. The thus-obtained arrangement contained 5.2% by weight partially-stabilised zirconia, based on the weight of fecralloy.

The coated arrangement was further provided with 1.1% wt Rh and 1.6% wt Zr, based on the total weight of the catalyst, by immersing it twice in an aqueous solution comprising rhodium trichloride and zirconyl nitrate. After each immersion, the arrangement was dried at 140° C. and calcined for 2 hours at 700° C.

Catalyst 3

A fecralloy wire arrangement having the same composition and dimensions as that used in catalyst 1 was calcined at a temperature of 1050° C. during 48 hours. The calcined arrangement was twice dipcoated in a commercially available partially-stabilised zirconia (Zirconium oxide, type ZO; ex. ZYP Coatings Inc., Oak Ridge, USA). The zirconia is partially-stabilised with 4% wt CaO. After dipcoating, the arrangement was calcined for 2 hours at 700° C. The thus-obtained arrangement contained 9.5% by weight partially-stabilised zirconia, based on the weight of fecralloy.

The coated arrangement was further provided with 1.4% wt Rh and 2.0% wt Zr, based on the total weight of the catalyst, by immersing it twice in an aqueous solution comprising rhodium trichloride and zirconyl nitrate. After each immersion, the arrangement was dried at 140° C. and calcined for 2 hours at 700° C.

Catalytic partial oxidation

Experiment 1 (not according to the invention)

Catalyst 1 (3.3 g) was retained in a 14 mm (internal diameter) quartz reactor tube. A feed mixture containing naphtha (506.6 g/h), air (1655 Nl/h) and steam (364 g/h) was fed to the catalyst. The temperature of the feed mixture was 250° C. The pressure was 6 bar (absolute). The conversion (% wt/wt) of naphtha to carbon oxides, i.e. the amount (wt) of carbon oxides produced per amount (wt) of naphtha introduced, was measured as a function of the hours on stream.

Experiment 2 (according to the invention)

The same experiment as in experiment 1 was repeated with catalyst 2 (3.5 g).

Experiment 3 (according to the invention)

The same experiment as in experiment 1 was repeated with catalyst 3 (3.5 g).

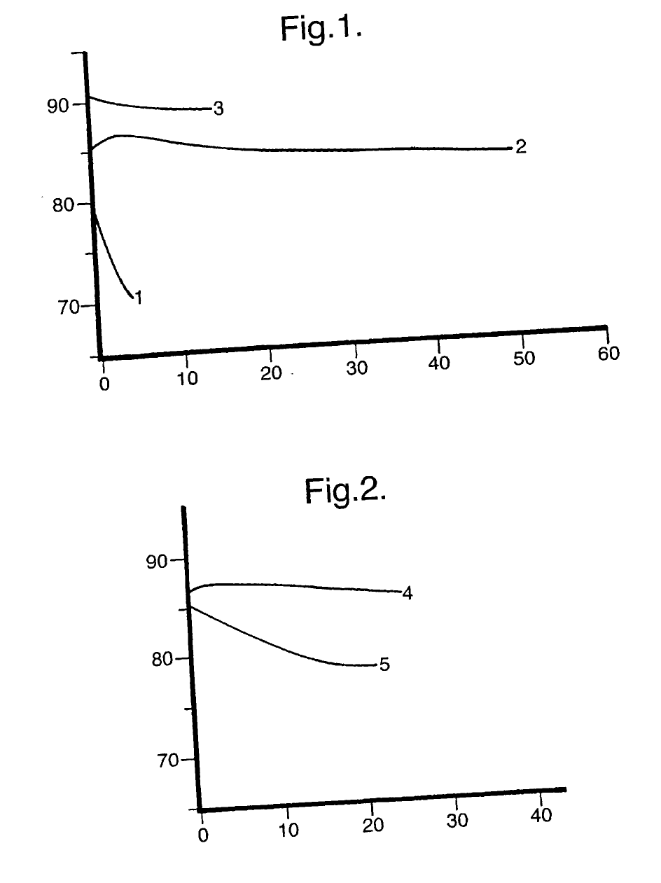

FIG. 1 shows the conversion (% wt/wt) of naphtha to carbon oxides versus run time for experiments 1, 2 and 3. The Y axis shows the conversion in % and the X axis shows the hours on stream. It can be seen that both the initial conversion and the stability of the catalyst are improved by using a catalyst carrier which is coated with a partially stabilised zirconia.

### EXAMPLE 2

### Catalyst Preparation

Catalyst 4

A commercially available structure of corrugated fecralloy foils (Katapak, ex. Sulzer, CH; corrugation length 1.2 mm) having a length of 6 cm and a diameter of 14 mm, was calcined for 48 hours at 1100° C. The calcined structure was once dipcoated in a commercially available partially-stabilised zirconia (Zirconium oxide, type ZO; ex. ZYP Coatings Inc., Oak Ridge, USA). The zirconia is partially-stabilised with 4% wt CaO. After dipcoating, the structure was calcined for 2 hours at 700° C. The thus-obtained structure contained 28% by weight partially-stabilised zirconia, based on the weight of fecralloy.

The coated structure was further provided with 2.3% wt Rh and 3.5% wt Zr, based on the total weight of the catalyst, by immersing it once in an aqueous solution comprising rhodium trichloride and zirconyl nitrate. After immersion, the structure was dried at 140° C. and calcined for 2 hours at 700° C.

Catalyst 5

A commercially available structure of corrugated fecralloy foils (Katapak, ex. Sulzer, CH; corrugation length 1.2 mm) having a length of 6 cm and a diameter of 14 mm, was calcined for 48 hours at 1100° C. The calcined structure was once dipcoated in a non-stabilised zirconia sol (ex. ZYP Coatings Inc., Oak Ridge, USA). After dipcoating, the structure was calcined for 2 hours at 700° C. The thus-obtained structure contained 27.5% by weight non-stabilised zirconia, based on the weight of fecralloy. The coated structure was further provided with 2.0% wt Rh and 3.1% wt Zr, based on the total weight of the catalyst, by immersing it once in an aqueous solution comprising rhodium trichloride and zirconyl nitrate. After immersion, the structure was dried at 140° C. and calcined for 2 hours at 700° C.

Catalytic partial oxidation

Experiment 4 (according to the invention)

Catalyst 4 (4.5 g) was retained in a 14 mm (internal diameter) quartz reactor tube. A catalytic partial oxidation process was carried out using the same feed mixture and the same process condition as in experiment 1.

Experiment 5 (not according to the invention)

Catalyst 5 (4.4 g) was retained in a 14 mm (internal diameter) quartz reactor tube. A catalytic partial oxidation process was carried out using the same feed mixture and the same process condition as in experiment 1.

FIG. 2 shows the conversion (% wt/wt) of naphtha to carbon oxides versus run time for experiments 4 and 5. The Y axis shows the conversion in % and the X axis shows the hours on stream. It can be seen that the stability of the catalyst wherein the carrier is coated with a partially-stabilised zirconia is higher than the stability of a catalyst wherein the carrier is coated with a non-stabilised zirconia.

1. A process for the catalytic partial oxidation of a hydrocarbonaceous feedstock comprising contacting the hydrocarbonaceous feedstock and an oxygen-containing gas with a catalyst in a reaction zone, wherein the catalyst comprises at least one metal selected from Group VIII of the Periodic Table supported on a ceramic or metal catalyst carrier, which carrier is coated with a stabilised or partially stabilised zirconia.

2. A process according to claim 1, wherein the zirconia is stabilised or partially stabilised with one or more oxides selected from oxides of Ca, Mg, Al, Ce, La, and Y, preferably from oxides of Ca and Y.

3. A process according to claim 1 or 2, wherein the carrier material is coated with an amount of stabilised or partially stabilised zirconia in the range of from 1 to 40% by weight, preferably in the range of from 2 to 30% by weight, more preferably in the range of from 3 to 15% by weight.

4. A process according to any of the preceding claims, wherein the catalyst is retained in the reaction zone in the form of a fixed arrangement.

5. A process according to any of the preceding claims, wherein the catalyst carrier is a metal catalyst carrier, preferably comprising an aluminium-containing alloy, more preferably an iron, chromium and aluminium-containing alloy.

6. A process according to claim 4 or 5, wherein the catalyst carrier is in the form of a foam.

7. A process according to claim 5, wherein the catalyst carrier is in the form of a three-dimensional arrangement of metal wire, foil, or gauze.

8. A process according to any of the preceding claims, wherein the at least one Group VIII metal is selected from Rh, Ir, Pt, and Pd, more preferably from Rh and Ir, even more preferably is an alloy of Rh and Ir.

9. A process according to any of the preceding claims, wherein the catalyst additionally comprises an inorganic metal cation selected from Al, Mg, Zr, Ti, La, Hf, Si, Ce and Ba, which is present in intimate association supported on or with the at least one Group VIII metal, preferably a zirconium cation.

10. A process according to any of the preceding claims, wherein the hydrocarbonaceous feedstock and the oxygen-containing gas are contacted with the catalyst for at least 5 hours, preferably for at least 10 hours.
